(19) United States
(12) Patent Application Publication
(10) Pub. No.: US 2024/0380005 A1
(43) Pub. Date: Nov. 14, 2024

(54) ASYMMETRIC SODIUM-BASED SOLID-STATE COMPOSITE ELECTROLYTE AND METHOD FOR PREPARING THE SAME AND BATTERY

(71) Applicant: KUNMING UNIVERSITY OF SCIENCE AND TECHNOLOGY, KUNMING (CN)

(72) Inventors: FENG LIANG, KUNMING (CN); DONGRONG YANG, KUNMING (CN); DA ZHANG, KUNMING (CN); BAOQIANG XU, KUNMING (CN); BIN YANG, KUNMING (CN)

(21) Appl. No.: 18/597,194

(22) Filed: Mar. 6, 2024

Related U.S. Application Data
(63) Continuation of application No. PCT/CN2023/093602, filed on May 11, 2023.

(51) Int. Cl. H01M 10/0565; H01M 10/054; H01M 50/403; H01M 50/414; H01M 50/451

(52) U.S. Cl. CPC H01M 10/0565; H01M 10/054; H01M 50/403; H01M 50/414; H01M 50/451; H01M 2300/0082; H01M 2300/0085; H01M 2300/0094

(57) ABSTRACT

An asymmetric sodium-based solid-state composite electrolyte includes a first solid-state composite electrolyte layer and a second composite electrolyte layer obtained by laminated coating method. Both the two solid-state composite electrolyte layers include a polymer matrix, an inorganic filler, a sodium salt and a plasticizer, the difference is the electron conductive agent added with the mass ratio ranges from 1 wt. %˜10 wt. % into the second solid-state composite electrolyte layer. In a battery assembled with the asymmetric sodium-based solid-state composite electrolyte, the first solid-state composite electrolyte layer is contiguous with a positive electrode, and the second solid-state composite electrolyte layer is disposed between the first solid-state composite electrolyte layer and a negative electrode.

### CROSS-REFERENCE TO RELATED APPLICATIONS

The application is a continuation of International Application No. PCT/CN2023/093602 filed on May 11, 2023.

### TECHNICAL FIELD

The present disclosure relates to the field of sodium batteries, in particular to an asymmetric laminated sodium-based solid-state composite electrolyte and a method for preparing the same and a battery.

### BACKGROUND

The sodium-ion battery is considered to be the most promising energy device to replace the lithium-ion battery use in electric vehicles, stationary power systems, removable power sources, and in the future large-scale energy storage field due to the high energy density, low cost and abundant resources. However, conventional sodium-ion batteries based on organic liquid electrolytes suffers from electrolyte leakage, flammability, poor thermal stability, and the morphology and orientation of sodium dendrite growth is not controllable, which reduces battery stability, in addition, the “dead sodium” results in reversible capacity loss and hindering the SIBs development.

### SUMMARY

Due to the shortcomings presented in the prior art, the purpose of the present disclosure is to solve one or more of the problems described above. For example, providing an asymmetric sodium-based solid-state composite electrolyte to improve the negative electrode-side interfacial stability and the life of sodium-ion battery.

An asymmetric sodium-based solid-state composite electrolyte, including a first solid-state composite electrolyte layer contiguous with a battery positive electrode, and a second solid-state composite electrolyte layer disposed between the first solid-state composite electrolyte layer and a battery negative electrode, wherein:
the first solid-state composite electrolyte layer includes a first polymer matrix and a first sodium salt; and
the second solid-state composite electrolyte layer includes a second polymer matrix, a second sodium salt, and an electron conductive agent, wherein the mass ratio of the electron conductive agent ranges from 1 wt. %˜10 wt. %.

In addition, the mass ratio of the first polymer matrix ranges from 15 wt. %˜95 wt. %, the first solid-state composite electrolyte layer further includes a first inorganic filler with the mass ratio ranging from 0.5 wt. %˜70 wt. %, and the molar ratio of sodium ions in the first sodium salt to polymer monomers in the first polymer matrix is (0˜1):20.

In addition, the second composite solid-state composite electrolyte layer includes a second inorganic filler with the mass ratio ranging from 0.5 wt. %˜70 wt. %, the mass ratio of the polymer matrix ranges from 15 wt. %˜95 wt. %, and the molar ratio of sodium ions in the second sodium salt to polymer monomers in the second polymer matrix is (0˜1):20.

In addition, the first inorganic filler or the second inorganic filler is one or more of Si, Al₂O₃, AlCl₃, BaTiO₃, CuO, SiO₂, ZrO₂, TiO₂, Na₁₊ₓZr₂SixP₃₋ₓO₁₂, and NaMM′P₃O₁₂, wherein 0<x<3, the M and M′ are any one of the Si²⁺, Mg²⁺, Cu²⁺, Co²⁺, Zn²⁺, Mn²⁺, Fe²⁺, Al³⁺, Cr³⁺, Sc³⁺, Y³⁺, La³⁺, Ti⁴⁺, Zr⁴⁺, Ge⁴⁺, Sn⁴⁺, Nb⁴⁺, V⁵⁺, Nb⁵⁺ and Ta⁵⁺; M and M′ can be the same element or not. and
the first sodium salt or the second sodium salt is one or more of NaClO₄, NaPF₆, NaAsF₆, NaBF₄, NaTFSI, NaTf, NaFSI and NaBOB.

In addition, the first solid-state composite electrolyte layer further includes a first plasticizer with the mass ratio ranging from 0.5 wt. %˜20 wt. %; and
the second solid-state composite electrolyte layer further includes a second plasticizer with the mass ratio ranging from 0.5 wt. %˜20 wt. %; and
the first plasticizer or the second plasticizer is one or more of succinonitrile, polystyrene, ethylene carbonate, propylene carbonate, polyethylene glycol, polyethylene glycol dimethyl ether, tetraethylene glycol, triethylene glycol dimethyl ether, diethyl phthalate, dioctyl phthalate, cyclic phosphate, dibutyl phthalate, and dimethyl phthalate.

In addition, the mass ratio of the first solid-state composite electrolyte layer to the second solid-state composite electrolyte layer is (1˜8):1.

In addition, the first polymer matrix or the second polymer matrix is one or more of polyethylene oxide, polyacrylonitrile, poly (methyl methacrylate), poly (vinyl alcohol), polyvinylpyrrolidone, polyvinylidene fluoride, poly (vinylidene fluoride-hexafluoropropylene), polypropylene carbonate, and polyethylene carbonate; or

the electron conductive agent is one or more of graphite, graphene, carbon nanotubes, acetylene black, and Ketjen Black carbon.

A method for preparing an asymmetric sodium-based solid-state composite electrolyte, including:
mixing a first mixture including a polymer matrix, an inorganic filler, a sodium salt, and a plasticizer into a first organic solvent by magnetic stirring to obtain a first solid-state composite electrolyte slurry; wherein, in the first mixture, the mass ratio of the polymer matrix ranges from 15 wt. %˜95 wt. %, the mass ratio of inorganic filler ranges from 0.5 wt. %˜70 wt. %, and the molar ratio of the sodium ions in sodium salt to polymer monomers in polymer matrix is (0˜1):20; and the mass ratio of the plasticizer ranges from 0.5 wt. %˜20 wt. %; and
knife coating the first solid-state composite electrolyte slurry in a mold, and air blast drying to obtain a first solid-state composite electrolyte layer; and
mixing a second mixture including a polymer matrix, an inorganic filler, a sodium salt, a plasticizer, and a conductive agent, into a second organic solvent by magnetic stirring to obtain a second solid-state composite electrolyte slurry; wherein, in the second mixture, the mass ratio of the polymer matrix ranges from 15 wt. %˜95 wt. %, the mass ratio of the inorganic filler ranges from 0.5 wt. %˜70 wt. %, and the molar ratio of the sodium ions in sodium salt to polymer monomers in polymer matrix is (0˜1):20; and the mass ratio of the plasticizer ranges from 0.5 wt. %˜20 wt. %, the mass ratio of the conductive agent ranges from 1 wt. %˜10 wt. %; and
knife coating the second solid-state composite electrolyte slurry onto the first solid-state composite electrolyte layer, air-blast drying and vacuum drying to obtain an asymmetric sodium-based solid-state composite electrolyte.

In addition, the first organic solvent or the second organic solvent is one or more of acetone, N,N-Dimethylformamide, and N-Methyl-2-pyrollidone.

In addition, the first organic solvent or the second organic solvent is one or more of acetone and N,N-dimethylformamide with the mass ratio ranging from (1˜25):1; or the first organic solvent or the second organic solvent is a mixture of the acetone and N-Methyl-2-pyrollidone with the mass ratio ranging from (1˜25):1.

In addition, the first solid-state composite electrolyte slurry is coated on a Teflon mold, followed by air-blast drying with the temperature ranging from 25° C.˜80° C. for 20 min˜120 min; the second solid-state composite electrolyte layer air-blast drying with temperature ranging from 25° C.˜80° C. for 30 min˜180 min, then vacuum drying with temperature ranging from 45° C.˜80° C. for 12 h˜36 h.

The third aspect of the present disclosure is a sodium-ion battery, which includes a positive electrode, a negative electrode, and the asymmetric sodium-based solid-state composite electrolyte positioned between the positive electrode and the negative electrode. The first solid-state composite electrolyte layer is contiguous with the positive electrode, and the second solid-state composite electrolyte layer is disposed between the first solid-state composite electrolyte layer and the negative electrode.

The benefits of the present disclosure include at least one of the following:
(1) The second solid-state composite electrolyte layer in the asymmetric sodium-based solid-state composite electrolyte is contiguous with the battery negative electrode, which introduces mixed ionic/electronic conductive properties for the negative electrode/electrolyte interface, conducive to enhancement the contacting between the negative electrode and the solid-state electrolyte, and release locally accumulated charges. Furthermore, it improves the sodium ions transport and uniform sodium deposition, thereby achieving high interfacial stability and long cycle life for a sodium-ion battery.
(2) The sodium-ion battery coupled with asymmetric sodium-based solid-state composite electrolyte represents excellent initial electrochemical performance.
(3) The cycling life and electrochemical performance of sodium-ion battery coupled with asymmetric sodium-based solid-state composite electrolyte is improving.

### BRIEF DESCRIPTION OF THE DRAWINGS

In order to clearly illustrate the technical solution in embodiments of the present disclosure, the accompanying drawings are briefly introduced below.

FIG. 1 is a scanning electron microscope (SEM) image of a first solid-state composite electrolyte layer according to Embodiment 1 of the present disclosure.

FIG. 2 is a scanning electron microscope (SEM) image of the second solid-state composite electrolyte layer according to the Embodiment 1 of the present disclosure.

FIG. 3 is a cross-sectional scanning electron microscope (SEM) of a solid-state composite electrolyte according to the Embodiment 1 of the present disclosure.

FIG. 4 is a schematic diagram of a sodium-ion battery assembled with the solid-state composite electrolyte according to the Embodiment 1.

FIG. 5 are charge/discharge curves for a Na|Na symmetric battery assembled with the solid-state composite electrolyte according to the Embodiment 1.

FIG. 6 are charge/discharge curves for a Na|Na symmetric battery assembled with the solid-state composite electrolyte according to Comparative Embodiment 1.

FIG. 7 are charge/discharge curves for Na|Na₃V₂(PO₄)₃ batteries assembled with the solid-state composite electrolyte according to the Embodiment 1 and Comparative Embodiment 1.

FIG. 8 are charge/discharge curves for Na|Na₃V₂(PO₄)₃ batteries assembled with the solid-state composite electrolyte according to Embodiment 2 and Embodiment 3.

FIG. 9 are rate performance curves for Na|Na₃V₂(PO₄)₃ batteries assembled with the solid-state composite electrolyte according to Embodiment 2 and Comparative Embodiment 2.

### DETAILED DESCRIPTION OF THE EMBODIMENTS

The present disclosure will be described in detail below with reference to the accompanying drawings and specific embodiments, but the protection scope of the present disclosure is not limited to the content.

In particular, solid-state sodium-ion batteries coupled with solid electrolytes can fundamentally address safety issues such as liquid electrolytes leaking, volatilization, gas production, and flammability in conventional sodium-ion batteries. Furthermore, solid-state sodium-ion batteries have advantages of high energy density, and environmentally friendly. It demonstrated their great potential for high energy density batteries, miniaturized batteries, and developing green energy sources.

The present disclosure discloses an asymmetric sodium-based solid-state composite electrolyte includes a first solid-state composite electrolyte layer and a second solid-state composite electrolyte layer. The second solid-state composite electrolyte layer is contiguous with the battery negative electrode, providing mixed ionic/electronic conductive properties for the negative electrode/electrolyte interface, which is conducive to enhancement the contacting between the negative electrode and the solid-state electrolyte, and improve the sodium ions transport and uniform sodium deposition, thereby achieving high interfacial stability and long cycle life for a sodium-ion battery.

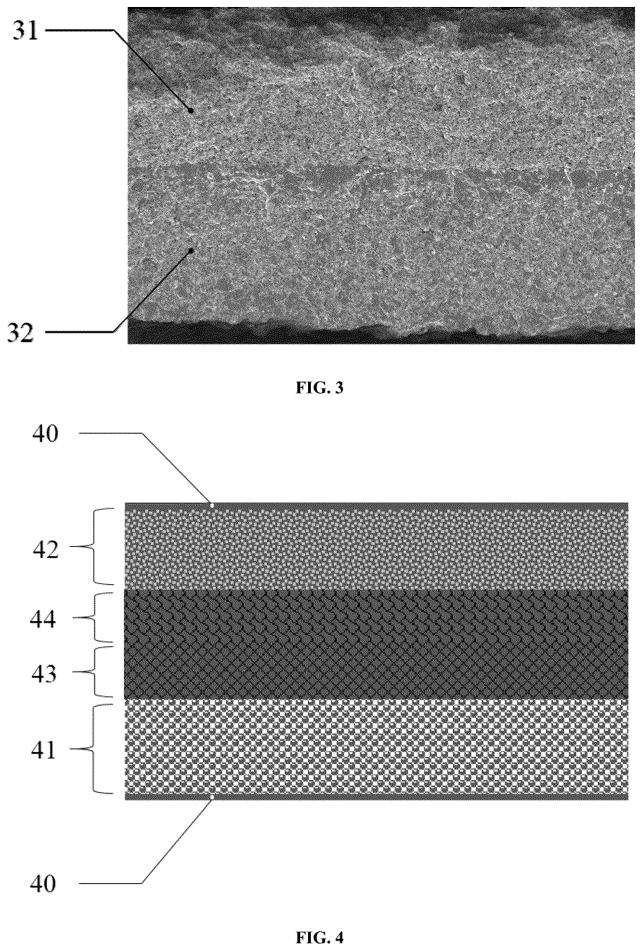

One aspect of the present disclosure is an asymmetric sodium-based solid-state composite electrolyte. In some embodiments, as shown in FIG. 3, the asymmetric sodium-based solid-state composite electrolyte includes a first solid-state composite electrolyte layer 31 and a second solid-state composite electrolyte layer 32, wherein the first solid-state composite electrolyte layer contiguous with the positive electrode, and a second solid-state composite electrolyte layer disposed between the first solid-state composite electrolyte layer and the negative electrode. The composition of the first solid-state composite electrolyte layer and the second solid-state composite electrolyte layer are different.

In addition, the first solid-state composite electrolyte layer includes a first polymer matrix, a first inorganic filler, a first sodium salt, and a first plasticizer (to improve the polymer plasticity and film forming properties); and
the second solid-state composite electrolyte layer includes a second polymer matrix, a second inorganic filler, a second sodium salt, a second plasticizer, and a second electron conductive agent.
the mass ratio of the electron conductive agent ranges from 1 wt. %˜10 wt. %. In general, contact interface between conventional solid electrolyte and the negative electrode is point to point, resulting in inhomogeneous sodium ion transport channels and charge distribution. Introducing a mixed ionic/electronic conducting layer between the solid electrolyte and the negative electrode is beneficial to disperse accumulated charges at the interface and to achieve a uniform sodium deposition. Additionally, 1 wt. %˜10 wt. % of the electron conductive agent can increase the amorphous region of the polymer matrix to improve the sodium ions diffusion kinetics in solid-state composite electrolyte. In some embodiments, the mass ratio of the electron conductive agent ranges from 2 wt. %˜9 wt. %, 3 wt. %˜8 wt. %, 4 wt. %˜7 wt. %, 5 wt. %˜6 wt. %, or combinations of the above ranges.

In some embodiments, the first solid-state composite electrolyte layer includes the first polymer matrix with the mass ratio ranging from 15 wt. %˜95 wt. %, the first inorganic filler with the mass ratio ranging from 0.5 wt. %˜70 wt. %, and the first plasticizer with the mass ratio ranging from 0.5 wt. %˜20 wt. %, the molar ratio of sodium ions in the first sodium salt to polymer monomers in the first polymer matrix is (0˜1):20. For example, the first solid-state composite electrolyte can includes 30 wt. %˜70 wt. % of the first polymer matrix, 12 wt. %˜60 wt. % of the first inorganic filler, 4 wt. %˜17 wt. % of the first plasticizer; or includes 32 wt. %˜68 wt. % of the first polymer matrix, 20 wt. %˜56 wt. % of the first inorganic filler, 7 wt. %˜15 wt. % of the first plasticizer, or a combination of the above ranges. The molar ratio of sodium ions in the first sodium salt to polymer monomers in the first polymer matrix can be 0.3:20, or 0.5:20, or 0.8:20, or combinations of the above ranges.

In some embodiments, the second solid-state composite electrolyte layer includes the second polymer matrix with the mass ratio ranging from 15 wt. %˜95 wt. %, the second inorganic filler with the mass ratio ranging from 0.5 wt. %˜70 wt. %, the second plasticizer with the mass ratio ranging from 0.5 wt. %˜20 wt. %, the second electron conductive agent with the mass ratio ranging from 1 wt. %˜10 wt. %.

Comparing with the solid-state organic polymer electrolyte, the solid-state inorganic active filler represents excellent ionic conductivity, high thermal stability, and inhibit dendrite growth, but solid-state inorganic electrolytes are difficult to process and poor interfacial contact. Therefore, it is necessary to control the amount of polymer matrix and inorganic filler. The present disclosure discloses an asymmetric sodium-based solid-state composite electrolyte including a polymer matrix and an inorganic filler in the ranges described above, which meets the requirement of high ionic conductivity, thermal stability, and inhibits dendrite growth while facilitating processing of the solid-state composite electrolyte. In order to optimize the ionic conductivity of the solid-state composite electrolyte without degrading the film forming performance, the molar ratio of the sodium ions in sodium salt to the polymer monomers in polymer matrix can be (0˜1):20.

In some embodiments, the inorganic filler can be absent (e.g., 0 wt. % by mass) in the first and second solid-state composite electrolyte layers. An inorganic filler is beneficial to improve the mechanical strength and ionic conductivity of the separator, but does not affect the preparation process of the asymmetric solid-state composite membrane. That is, the first solid-state composite electrolyte layer and the second solid-state composite electrolyte layer solve the technical problem of the present disclosure and achieve the technical effect of the present disclosure even if the inorganic filler if absent, except lower ionic conductivity; the purpose of incorporating an inorganic filler is to make the asymmetric sodium-based solid-state composite electrolyte of the present disclosure perform better.

In some embodiments, the plasticizer can be absent (e.g., 0 wt. % by mass) in the first and second solid-state composite electrolyte layer of the present disclosure. The purpose of a plasticizer in the present disclosure is to improve the film formation of the polymer matrix during the process, uniformly disperse the polymer, sodium salt, and improve the ionic conductivity of the composite film. That is, the first solid-state composite electrolyte layer and the second solid-state composite electrolyte layer solve the technical problem of the present disclosure and achieve the technical effect of the present disclosure even if a plasticizer is absent, the purpose of introducing a plasticizer is to make the asymmetric sodium-based solid-state composite electrolyte of the present disclosure perform better.

For example, the second solid-state composite electrolyte layer includes the second polymer matrix with the mass ratio ranging from 20 wt. %˜85 wt. %, the second inorganic filler with the mass ratio ranging from 5 wt. %˜70 wt. %, the second plasticizer with the mass ratio ranging from 4 wt. %˜17 wt. %, and the electron conductive agent with the mass ratio ranging from 1 wt. %˜8 wt. %; or
the second polymer matrix with the mass ratio ranging from 22 wt. %˜80 wt. %, the second inorganic filler with the mass ratio ranging from 7 wt. %˜65 wt. %, the second plasticizer with the mass ratio ranging from 5 wt. %˜12 wt. %, and the second electron conductive agent with the mass ratio ranging from 3 wt. %˜6 wt. %; and
the molar ratio of sodium ions in the second sodium salt to polymer monomers in the second polymer matrix ranges from (0˜1):20. For example, the molar ratio of sodium ions in the second sodium salt to polymer monomers in the second polymer matrix can be 0.3:20, or 0.5:20, or 0.7:20, or 0.9:20, or combinations of the above ranges.

In some embodiments, the mass ratio of the first solid-state composite electrolyte layer to the second solid-state composite electrolyte layer ranges from (1˜8):1. For example, the mass ratio of the first solid-state composite electrolyte layer to the second solid-state composite electrolyte layer can be 3:1, 5:1, 6:1, 7:1, or combinations of the above ranges.

In some embodiments, the thickness of the second solid-state composite electrolyte layer ranges from 0.1 mm to 1 mm. The thickness of the second solid-state composite electrolyte layer in above-described ranges can reduce the cost of electron conductive agent while ensuring good performance of the solid-state composite electrolyte. For example, the thickness of the second solid-state composite electrolyte layer is 0.2 mm or 0.5 mm.

In some embodiments, the first polymer matrix or the second polymer matrix is one or more of polyethylene oxide (PEO), polyacrylonitrile (PAN), poly (methyl methacrylate) (PMMA), poly (vinyl alcohol) (PVA), polyvinylpyrrolidone (PVP), polyvinylidene fluoride (PVDF), poly (vinylidene fluoride-hexafluoropropylene) (PVDF-HFP), polypropylene carbonate (PPC), and polyethylene carbonate (PEC).

In some embodiments, the first inorganic filler or the second inorganic filler is one or more of Si, Al₂O₃, AlCl₃, BaTiO₃, CuO, SiO₂, ZrO₂, TiO₂, Na₁₊ₓZr₂SiₓP₃₋ₓO₁₂ (0<x<3) and NaMM′P₃O₁₂, wherein M and M′ may be any one of Si²⁺, Mg²⁺, Cu²⁺, Co²⁺, Zn²⁺, Mn²⁺, Fe²⁺, Al³⁺, Cr³⁺, Sc³⁺, Y³⁺, La³⁺, Ti⁴⁺, Zr⁴⁺, Ge⁴⁺, Sn⁴⁺, Nb⁴⁺, V⁵⁺, Nb⁵⁺, and Ta⁵⁺, respectively, M and M′ can be the same element or not.

In some embodiments, the first sodium salt or the second sodium salt is one or more of NaClO₄, NaPF₆, NaAsF₆, NaBF₄, NaTFSI, NaTf, NaFSI, and NaBOB.

In some embodiments, the first plasticizer or the second plastizer is one or more of succinonitrile, polystyrene, ethylene carbonate, propylene carbonate, polyethylene glycol, polyethylene glycol dimethyl ether, tetraethylene glycol, triethylene glycol dimethyl ether, diethyl phthalate, dioctyl phthalate, cyclic phosphate, dibutyl phthalate, and dimethyl phthalate.

In some embodiments, the conductive agent in the second solid-state composite electrolyte is one or more of graphite, graphene, carbon nanotubes, acetylene black, and Ketjen Black carbon.

In some embodiments, the asymmetric layered sodium-based solid-state composite electrolytes provided herein can be used as a separator for sodium-ion batteries.

Another aspect of the present disclosure provides a preparing method for preparing the asymmetric sodium-based solid-state composite electrolyte, including:
Step 01, mixing a polymer matrix, an inorganic filler, a sodium salt, and a plasticizer into a first organic solvent by magnetic stirring to obtain a first solid-state composite electrolyte slurry;
Step 02, knife coating the first solid-state composite electrolyte slurry in a mold, followed by air-blast drying to obtain a first solid-state composite electrolyte layer;
Step 03, mixing a polymer matrix, an inorganic filler, a sodium salt, a plasticizer, and a conductive agent, into a second organic solvent by magnetic stirring to obtain a second solid-state composite electrolyte slurry;
Step 04, knife coating the second solid-state composite electrolyte slurry onto the first solid-state composite electrolyte layer, followed by air-blast drying, vacuum drying to obtain the asymmetric sodium-based solid-state composite electrolyte.

In some embodiments, the amount of the raw materials for the above preparation method are consistent with the composition of the asymmetric sodium-based solid-state composite electrolyte, e.g., the first solid-state composite electrolyte layer includes the first polymer matrix with the mass ratio ranging from 15 wt. %˜95 wt. %, the first inorganic filler with the mass ratio ranging from 0.5 wt. %˜70 wt. %, and the first plasticizer with the mass ratio ranging from 0.5 wt. %˜20 wt. %, the molar ratio of sodium ions in the first sodium salt to polymer monomers in the first polymer matrix is (0˜1):20; the second solid-state composite electrolyte layer includes the second polymer matrix with the mass ratio ranging from 15 wt. %˜95 wt. %, the second inorganic filler with the mass ratio ranging from 0.5 wt. %˜70 wt. %, and the second plasticizer with the mass ratio ranging from 0.5 wt. %˜20 wt. %, and the second electron conductive agent with the mass ratio ranging from 1 wt. %˜10 wt. %, which are not described in detail herein.

In some embodiments, the organic solvent in the first and second sodium-based solid-state composite electrolyte slurry is one or more of acetone, N,N-dimethylformamide, and N-Methyl-2-pyrollidone; or the organic solvent is a mixture of acetone and N,N-dimethylformamide with the mass ratio ranging from (1˜25):1; or the organic solvent is a mixture of acetone and N-Methyl-2-pyrollidone with the mass ratio ranging from (1˜25):1. For example, the organic solvent is a mixture of acetone and N,N-dimethylformamide with the mass ratio of 15:1; alternatively, or the organic solvent is a mixture of acetone and N-Methyl-2-pyrollidone with the mass ratio of 18:1.

In some embodiments, the mass ratio of the first organic solvent in the first solid-state composite electrolyte slurry ranges from 67 wt. %˜83 wt. %. For example, the mass ratio is 70 wt. %, 75 wt. %, 79 wt. %, 81 wt. %, or combinations of the above ratios.

In some embodiments, the mass ratio of the second organic solvent in the second solid-state composite electrolyte slurry ranges from 67 wt. %˜83 wt. %. For example, the mass ratio is 70 wt. %, 72 wt. %, 75 wt. %, 79 wt. %, 81 wt. %, or combinations of the above ratios.

In some embodiments, the first solid-state composite electrolyte slurry was obtained by magnetic stirring for 6 h˜18 h at 25° C.˜60° C. For example, magnetic stirring for 12 h at 45° C.

In some embodiments, the second solid-state composite electrolyte slurry was obtained by magnetic stirring for 6 h˜18 h at 25° C.˜60° C. For example, magnetic stirring for 14 h at 52° C.

In some embodiments, the mold can be polytetrafluoroethylene. The slot depth of the mold ranges from 0.1 mm˜1 mm. For example, the depth of the mold is 0.5 mm.

In some embodiments, first solid-state composite electrolyte layer obtained by knife coating the first solid-state composite electrolyte slurry in the mold with the air blast drying temperature in 25° C.˜80° C. for 20 min˜120 min. For example, air blast drying for 50 min at 60° C.

In some embodiments, the mass ratio of the first solid-state composite electrolyte slurry to the second solid-state composite electrolyte slurry is (1˜8):1, for example, the mass ratio is 5:1.

In some embodiments, asymmetric sodium-based solid-state composite electrolyte was obtained by knife coating the second solid-state composite electrolyte slurry on the first solid-state composite electrolyte layer with the air blast drying temperature in 25° C.˜80° C. for 30 min˜180 min, then vacuum drying in 45° C.˜80° C. for 12 h˜36 h. For example, the air blast drying for 120 min at 55° C. then vacuum drying for 20 h at 65° C.

The third aspect of the present disclosure provides a sodium-ion battery, which including: a negative electrode and an asymmetric sodium-based composite solid electrolyte as described above or as prepared by the method described above. The asymmetric sodium-based solid-state composite electrolyte includes a first solid-state composite electrolyte layer contiguous with the positive electrode, and a second solid-state composite electrolyte layer disposed between the first solid-state composite electrolyte layer and the negative electrode.

In some embodiments, the sodium-ion battery includes the asymmetric sodium-based solid-state composite electrolyte described above, which disposed between the positive electrode and the negative electrode. As shown in FIG. 4, 40 refers to a current collector, 41 refers to a positive electrode, 42 refers to a negative electrode, 43 refers to a first solid-state composite electrolyte layer, and 44 refers to a second solid-state composite electrolyte layer disposed between the negative electrode 42 and the first solid-state composite electrolyte layer 43.

In order for further clarity, the present disclosure will be described in detail in combination with specific embodiments, but the present disclosure is not limited only to the following embodiments.

### Embodiment 1

Step One: weighting 0.81 g PEO, 0.14 g diethyl phthalate, 0.01 g NaFSI, 3 g acetone, and 2.5 g N,N-dimethylformamide in an argon-filled glove box with the moisture content lower than 0.1 ppm, then mixing them by magnetic stirring for 3 h at 50° C. to obtain a first solution; then weighting 0.45 g Na₃Zr₂Si₂PO₁₂ powder and adding into the solution and magnetic stirring for 18 h at 50° C. to obtain a first solid-state composite electrolyte slurry.

Weighting 0.81 g PEO, 0.14 g diethyl phthalate, 0.01 g NaFSI, 3 g acetone, and 2.5 g N,N-dimethylformamide in above glove box, mixing them by magnetic stirring for 3 h at 50° C. to obtain a second solution; then weighting 0.54 g Na₃Zr₂Si₂PO₁₂ powder and 0.04 g graphite and adding into the second solution and magnetic stirring for 18 h at 50° C. to obtain a second solid-state composite electrolyte slurry.

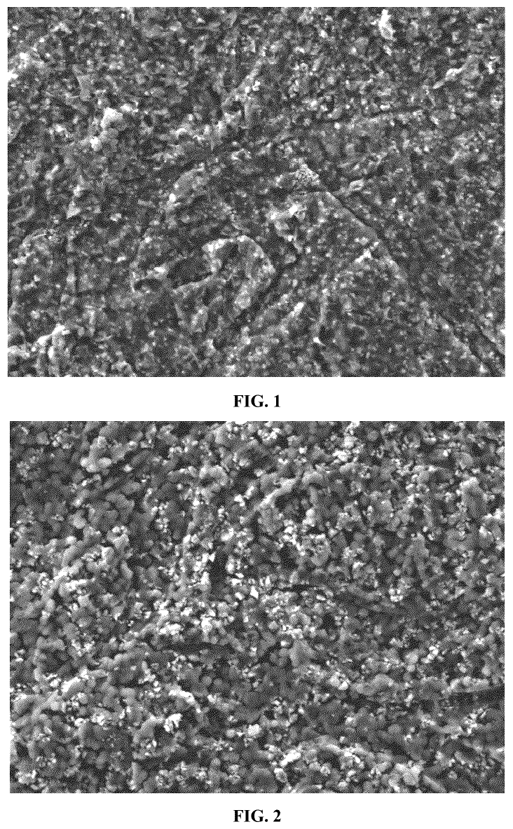

Step Two: knife coating the first solid-state composite electrolyte slurry in a Teflon mold with the dimension of 160×70×0.5 mm, then air-blast drying for 30 min at 45° C. to obtain a first solid-state composite electrolyte layer, the SEM image of the morphological of which is shown in FIG. 1. knife coating the second solid-state composite electrolyte slurry onto the first solid-state composite electrolyte layer and air-blast drying for 60 min at 50° C., vacuum drying for 24 h at 60° C., and an asymmetric sodium-based solid-state composite electrolyte was obtained, the SEM image of the second solid-state composite electrolyte layer is shown in FIG. 2.

The cross-sectional SEM images of the asymmetric sodium-based solid-state composite electrolytes as obtained is shown in FIG. 3, and exhibits great adhesion across the interfaces of two layers with the Na conductivity of 2.13×10+S cm 1.

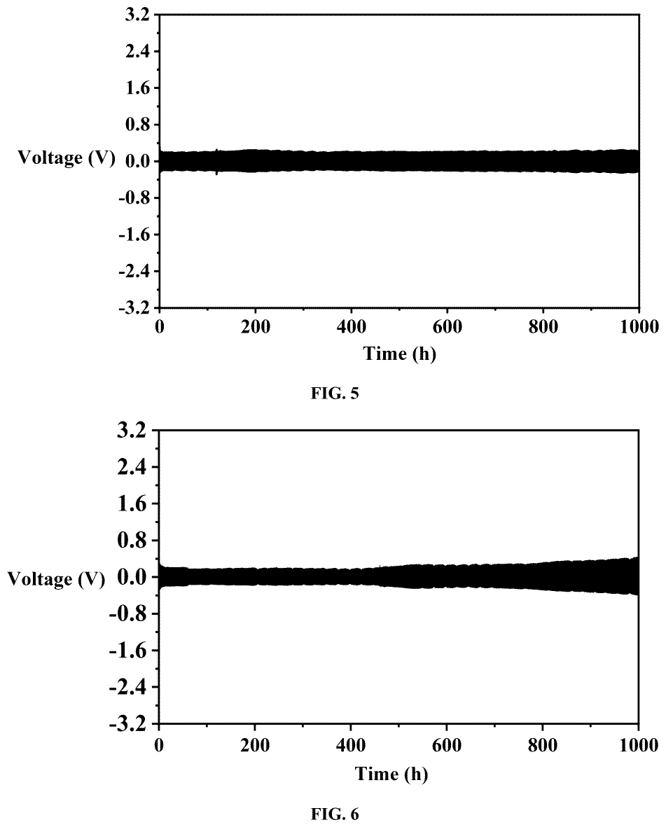

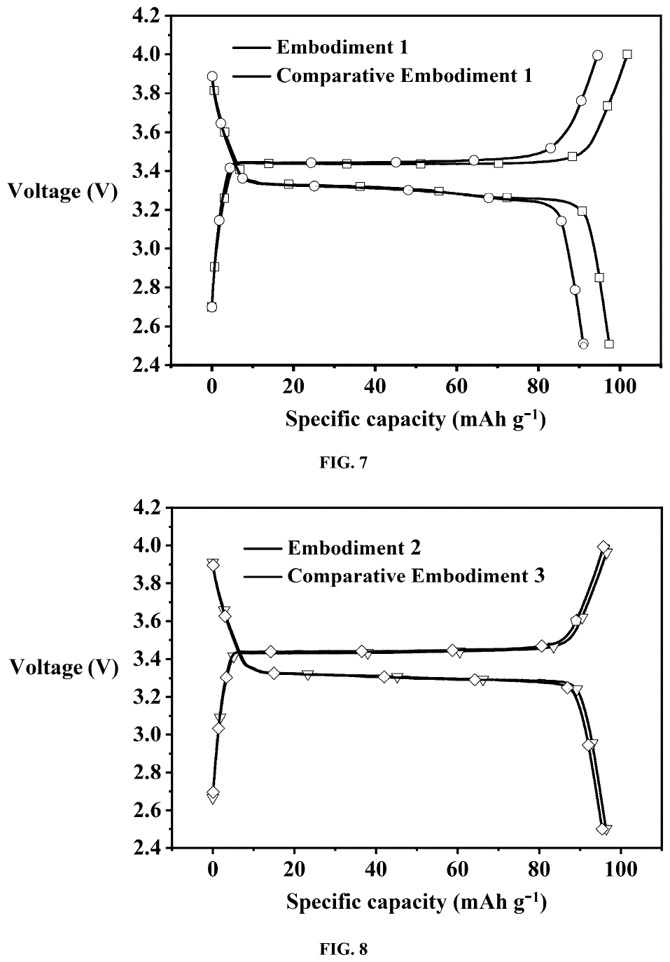

Step three: the laminated solid-state composite electrolyte is cut into a sphere of $19 mm to serve as a separator and solid electrolyte for a CR2032 coin battery. The Na|Na symmetric battery with liquid electrolyte interfacial infiltration is shown in FIG. 4; charge/discharge cycle performance of the Na|Na symmetric battery under 0.1 mA cm 1 is shown in FIG. 5; The first charge/discharge cycle performance of the Na|Na₃V₂(PO₄)₃ (CR2032) battery under 0.1 C with the voltage ranges from 2.3˜3.8V is shown in FIG. 7.

### Embodiment 2

Step One: weighting 0.81 g PEO, 0.27 g diethyl phthalate, 0.07 g NaClO₄, 3.2 g acetone, 2.5 g N,N-dimethylformamide in an argon-filled glove box with the moisture content lower than 0.1 ppm, mixing them by magnetic stirring for 3 h at 40° C. to obtain a first solution; then weighting 0.63 g Na_{3.4}Zr_{1.8}Mg_{0.2}Si₂PO₁₂ powder and adding into the solution and magnetic stirring for 18 h at 40° C. to obtain a first solid-state composite electrolyte slurry.

Weighting 0.81 g PEO, 0.27 g diethyl phthalate, 0.07 g NaClO₄, 3.2 g acetone, 2.5 g N,N-dimethylformamide in above glove box, mixing them by magnetic stirring for 3 h at 40° C. to obtain a second solution; then weighting 0.63 g Na_{3.4}Zr_{1.8}Mg_{0.2}Si₂PO₁₂ powder and 0.04 g graphite and adding into the second solution and magnetic stirring for 18 h at 40° C. to obtain a second solid-state composite electrolyte slurry.

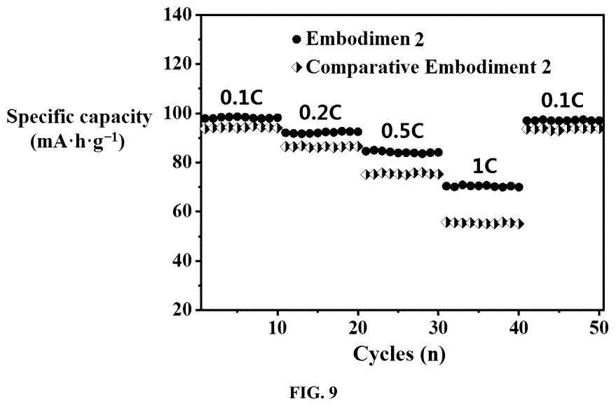

The following steps are same to the step two and step three in Embodiment 1. The Na-⁺ conductivity of asymmetric sodium-based solid-state composite electrolyte as obtained in Embodiment 2 is 2.16×10⁻⁴ S cm⁻¹. The first charge/discharge cycle performance of the Na|Na₃V₂(PO₄)₃ (CR2032) battery under 0.1 C with the voltage ranges from 2.3˜3.8V is shown in FIG. 7, and the rate capability of the Na|Na₃V₂(PO₄)₃ battery is shown in FIG. 9.

### Embodiment 3

Step One: weighting 0.81 g PEO, 0.14 g tetraethylene glycol, 0.01 g NaClO₄ and 5.5 g N, N-dimethylformamide in an argon-filled glove box with the c moisture content lower than 0.1 ppm, mixing them by magnetic stirring for 3 h at 45° C. to obtain a first solution; then weighting 0.54 g Na₃Zr₂Si₂PO₁₂ powder and adding into the solution and magnetic stirring for 18 h at 45° C. to obtain a first solid-state composite electrolyte slurry.

Weighting 0.81 g PEO, 0.14 g tetraethylene glycol, 0.07 g NaClO₄ and 5.5 g N,N-dimethylformamide in above glove box, mixing them by magnetic stirring for 3 h at 45° C. to obtain a second solution; then weighting 0.54 g Na₃Zr₂Si₂PO₁₂ powder and 0.08 g acetylene black and adding into the second solution and magnetic stirring for 18 h at 45° C. to obtain a second solid-state composite electrolyte slurry.

The following steps are—same to the step two and step three in Embodiment 1. The Na-⁺ conductivity of asymmetric sodium-based solid-state composite electrolyte as obtained in Embodiment 3 is 1.98×10 4 S cm 1. The first charge/discharge cycle performance of the Na|Na₃V₂(PO₄)₃ battery (CR2032) is shown in FIG. 8.

### Embodiment 4

Step One: weighting 0.59 g PEO, 0.14 g dibutyl phthalate, 0.01 g NaFSI, 3 g acetone, and 4 g N,N-dimethylformamide in an argon-filled glove box with the moisture content lower than 0.1 ppm, mixing them by magnetic stirring for 3 h at 45° C. to obtain a first solution; then weighting 1.08 g Na_{3.4}Zr_{1.8}Mg_{0.2}Si₂PO₁₂ powder and adding into the solution and magnetic stirring for 18 h at 45° C. to obtain a first solid-state composite electrolyte slurry.

Weighting 0.59 g PEO, 0.135 g dibutyl phthalate, 0.01 g NaFSI, 3 g acetone, and 4 g N,N-dimethylformamide in above glove box, mixing them by magnetic stirring for 3 h at 45° C. to obtain a second solution; then weighting 1.08 g the Na_{3.4}Zr_{1.8}Mg_{0.2}Si₂PO₁₂ powder and 0.08 g the graphite and adding into the second solution and magnetic stirring for 18 h at 45° C. to obtain a second solid-state composite electrolyte slurry.

The following steps are—same to the step two and step three in Embodiment 1. The Na-⁺ conductivity of asymmetric sodium-based solid-state composite electrolyte as obtained in Embodiment 4 is 2.27×10⁻⁴ S cm⁻¹.

### Embodiment 5

Step One: weighting 0.59 g PEO, 0.14 g tetraethylene glycol, 0.01 g NaClO₄, 3 g acetone, and 3.3 g N,N-dimethylformamide in an argon-filled glove box with the moisture content lower than 0.1 ppm, mixing them by magnetic stirring for 3 h at 45° C. to obtain a first solution; then weighting 1.08 g the Na₃Zr₂Si₂PO₁₂ powder and add into the solution and magnetic stirring for 18 h at 45° C. to obtain a first solid-state composite electrolyte slurry.

Weighting 0.59 g PVDF-HFP, 0.135 g tetraethylene glycol, 0.01 g NaClO₄, 3 g acetone, and 3.3 g N,N-dimethylformamide in above glove box, mixing them by magnetic stirring for 3 h at 45° C. to obtain a second solution; then weighting 1.08 g the Na₃Zr₂Si₂PO₁₂ powder and 0.08 g graphene and adding into the second solution and magnetic stirring for 18 h at 45° C. to obtain a second solid-state composite electrolyte slurry.

The following steps are—same to the step two and step three in Embodiment 1. The Na-⁺ conductivity of asymmetric sodium-based solid-state composite electrolyte as obtained in Embodiment 5 is 2.58× 10⁻⁴ S cm⁻¹.

### Comparative Embodiment 1

Step One: weighting 0.81 g PEO, 0.14 g tetraethylene glycol, 0.01 g NaClO₄, 3 g acetone, and 3.5 g N,N-dimethylformamide in an argon-filled glove box with the moisture content lower than 0.1 ppm, mixing them by magnetic stirring for 3 h at 45° C. to obtain a first solution; then weighting 0.54 g the Na₃Zr₂Si₂PO₁₂ powder and adding into the solution and magnetic stirring for 18 h at 45° C. to obtain a first solid-state composite electrolyte slurry. The second solid-state composite electrolyte slurry is obtained by the same method with the first solid-state composite electrolyte slurry in Comparative Embodiment 1.

The following steps are same to the step two and step three in Embodiment 1. The Na-⁺ conductivity of solid-state composite electrolyte as obtained in Comparative Embodiment 1 is 1.53×10 4 S cm 1. The charge/discharge cycle performance of the Na|Na symmetric battery under 0.1 mA cm 1 is shown in FIG. 6; the first charge/discharge cycle performance of Na|Na₃V₂(PO₄)₃ (CR2032) battery under 0.1 C with the voltage ranges from 2.3˜3.8V is shown in FIG. 7.

### Comparative Embodiment 2

Step One: weighting 8.1 g PEO, 0.27 g dibutyl phthalate, 0.07 g NaClO₄, 3 g acetone, and 2.5 g N,N-dimethylformamide in an argon-filled glove box with the moisture content lower than 0.1 ppm, then mixing them by magnetic stirring for 3 h at 45° C. to obtain a first solution; then weighting 0.72 g Na_{3.4}Zr_{1.8}Mg_{0.2}Si₂PO₁₂ powder and adding into the solution and magnetic stirring for 18 h at 45° C. to obtain a first solid-state composite electrolyte slurry.

Weighting 0.81 g PEO, 0.27 g dibutyl phthalate, 0.07 g NaClO₄, 3.5 g acetone, and 2.5 g N,N-dimethylformamide in above glovebox, mixing them by magnetic stirring for 3 h at 45° C. to obtain a second solution; then weighting 0.72 g Na_{3.4}Zr_{1.8}Mg_{0.2}Si₂PO₁₂ powder and adding into the second solution and magnetic stirring for 18 h at 45° C. to obtain a second solid-state composite electrolyte slurry.

The following steps are—same to the step two and step three in Embodiment 1. The Na-⁺ conductivity of asymmetric sodium-based solid-state composite electrolyte as obtained in Comparative Embodiment 2 is 1.37×10⁻⁴ S cm 1.

### Comparative Embodiment 3

Step One: Weighting 0.81 g PEO, 0.135 g diethyl phthalate, 0.01 g NaFSI, 3 g acetone, and 2.5 g N,N-dimethylformamide in an argon-filled glove box with the moisture content lower than 0.1 ppm, hen mixing them by magnetic stirring for 3 h at 45° C. to obtain a solution; then weighting 0.63 g Na₃Zr₂Si₂PO₁₂ powder and adding into the solution and magnetic stirring for 18 h at 45° C. to obtain a solid-state composite electrolyte slurry.

Step Two: knife coating the composite solid electrolyte slurry in a Teflon mold with the dimension of 160×70×0.5 mm, then air-blast drying for 120 min at 60° C., and vacuum drying for 24 h at 60° C., and a single layer sodium-based solid-state composite electrolyte was obtained.

The following steps are same to the step two and step three in Embodiment 1. The Na-⁺ conductivity of asymmetric sodium-based solid-state composite electrolyte as obtained in Comparative Embodiment 3 is 1.34×10⁻⁴ S cm⁻¹.

The data of Na-⁺ ionic conductivity and discharge capacity in a first cycle for Embodiment 1˜5 and Comparative Embodiment 1˜3 is listed in the following table. Obviously, the Na|Na₃V₂(PO₄)₃ (CR2032) batteries coupled with the asymmetric solid-state composite electrolytes provided in the present disclosure represent higher first charge capacity at 0.1 C than the single layer solid-state composite electrolyte and symmetric solid-state composite electrolyte; the Na|Na symmetric (CR2032) batteries coupled with asymmetric sodium-based solid-state composite electrolytes provided in the present disclosure represent better charge/discharge cycling stability than the symmetric solid-state composite electrolytes, indicate the sodium ion conductivity and electrochemical stability of solid-state composite electrolytes can be improved by method disclosed in the present disclosure

| | Na⁺ ionic | Discharge capacity |
|---|---|---|
| | conductivity | at first cycle |
| Contents | (×10⁻⁴ S cm⁻¹) | (mA · h · g⁻¹) |
| Embodiment 1 | 2.13 | 97.5 |
| Embodiment 2 | 2.16 | 96.1 |
| Embodiment 3 | 1.98 | 95.4 |
| Embodiment 4 | 2.27 | 98.1 |
| Embodiment 5 | 2.58 | 97.6 |
| Comparative Embodiment 1 | 1.53 | 90.8 |
| Comparative Embodiment 2 | 1.37 | 91.3 |
| Comparative Embodiment 3 | 1.34 | 90.6 |

Compared with the charge/discharge cycling curve in and FIG. 6, the cycling stability of the Na|Na symmetric battery coupled with asymmetric sodium-based solid-state composite electrolyte (as shown in FIG. 5) is higher than the symmetric solid-state composite electrolytes.

The first charge/discharge curves of Na|Na₃V₂(PO₄)₃ (CR2032) batteries coupled with the solid-state composite electrolytes discloses in Embodiment 1 and Comparative Embodiment 1 is shown in FIG. 7. The first charge/discharge curves of Na|Na₃V₂(PO₄)₃ (CR2032) coupled with the composite solid electrolytes and discloses in Embodiment 2 and Embodiment 3 is shown in FIG. 8. Obviously, the first discharge specific capacities coupled asymmetric sodium-based solid-state composite electrolyte is higher than that symmetric sodium-based solid-state composite electrolytes.

The rate performance curves of the Na|Na₃V₂(PO₄)₃ (CR2032) batteries coupled with the solid-state composite electrolytes discloses in Embodiment 2 and Comparative Embodiment 2 is shown in FIG. 9. Obviously, the asymmetric sodium-based solid-state composite electrolyte reflects higher rate capability.

Although this present has been described above by combining exemplary embodiments, it should be clear to people in this field that various modifications and changes may be allowed without deviating from the scope of the claims.

1. An asymmetric sodium-based solid-state composite electrolyte, comprising a first solid-state composite electrolyte layer contiguous with a battery positive electrode, and a second solid-state composite electrolyte layer disposed between the first solid-state composite electrolyte layer and a battery negative electrode, wherein:
the first solid-state composite electrolyte layer comprises a first polymer matrix and a first sodium salt; and
the second solid-state composite electrolyte layer comprises a second polymer matrix, a second sodium salt, and an electron conductive agent, wherein the mass ratio of the electron conductive agent ranges from 1 wt. %˜10 wt. %.

2. The asymmetric sodium-based solid-state composite electrolyte according to claim 1, wherein the mass ratio of the first polymer matrix ranges from 15 wt. %˜95 wt. %, the first solid-state composite electrolyte layer further comprises a first inorganic filler with the mass ratio ranging from 0.5 wt. %˜70 wt. %, and the molar ratio of sodium ions in the first sodium salt to polymer monomers in the first polymer matrix is (0˜1):20.

3. The asymmetric sodium-based solid-state composite electrolyte according to claim 2, wherein the second composite solid-state composite electrolyte layer comprises a second inorganic filler with the mass ratio ranging from 0.5 wt. %˜70 wt. %, the mass ratio of the polymer matrix ranges from 15 wt. %˜95 wt. %, and the molar ratio of sodium ions in the second sodium salt to polymer monomers in the second polymer matrix is (0˜1):20.

4. The asymmetric sodium-based solid-state composite electrolyte according to claim 3, wherein the first inorganic filler or the second inorganic filler is one or more of Si, Al₂O₃, AlCl₃, BaTiQ₃, CuO, SiO₂, ZrO₂, TiQ₂, Na₁₊ₓZr₂SiₓP₃₋ₓO₁₂, and NaMM′P₃O₁₂, wherein 0<x<3, the M and M′ are any one of the Si²⁺, Mg²⁺, Cu²⁺, Co²⁺, Zn²⁺, Mn²⁺, Fe²⁺, Al³⁺, Cr³⁺, Sc³⁺, Y³⁺, La³⁺, Ti⁴⁺, Zr⁺⁴, Ge⁴⁺, Sn⁴⁺, Nb⁴⁺, V⁵⁺, Nb⁵⁺, and Ta⁵⁺; M and M′ can be the same element or not. and
the first sodium salt or the second sodium salt is one or more of NaClO₄, NaPF₆, NaAsF₆, NaBF₄, NaTFSI, NaTf, NaFSI and NaBOB.

5. The asymmetric sodium-based solid-state composite electrolyte according to claim 1, wherein the first solid-state composite electrolyte layer further comprises a first plasticizer with the mass ratio ranging from 0.5 wt. %˜20 wt. %; and
the second solid-state composite electrolyte layer further comprises a second plasticizer with the mass ratio ranging from 0.5 wt. %˜20 wt. %;
the first plasticizer or the second plasticizer is one or more of succinonitrile, polystyrene, ethylene carbonate, propylene carbonate, polyethylene glycol, polyethylene glycol dimethyl ether, tetraethylene glycol, triethylene glycol dimethyl ether, diethyl phthalate, dioctyl phthalate, cyclic phosphate, dibutyl phthalate, and dimethyl phthalate.

6. The asymmetric sodium-based solid-state composite electrolyte according to claim 1, wherein the mass ratio of the first solid-state composite electrolyte layer to the second solid-state composite electrolyte layer is (1˜8):1.

7. The asymmetric sodium-based solid-state composite electrolyte according to claim 1, wherein the first polymer matrix or the second polymer matrix is one or more of polyethylene oxide, polyacrylonitrile, poly (methyl methacrylate), poly (vinyl alcohol), polyvinylpyrrolidone, polyvinylidene fluoride, poly (vinylidene fluoride-hexafluoropropylene), polypropylene carbonate, and polyethylene carbonate; or
the electron conductive agent is one or more of graphite, graphene, carbon nanotubes, acetylene black, and Ketjen Black carbon.

8. A method for preparing an asymmetric sodium-based solid-state composite electrolyte, comprising:
mixing a first mixture including a polymer matrix, an inorganic filler, a sodium salt, and a plasticizer into a first organic solvent by magnetic stirring to obtain a first solid-state composite electrolyte slurry; wherein, in the first mixture, the mass ratio of the polymer matrix ranges from 15 wt. %˜95 wt. %, the mass ratio of inorganic filler ranges from 0.5 wt. %˜70 wt. %, and the molar ratio of the sodium ions in sodium salt to polymer monomers in polymer matrix is (0˜1):20; and the mass ratio of the plasticizer ranges from 0.5 wt. %˜20 wt. %;
knife coating the first solid-state composite electrolyte slurry in a mold, and air blast drying to obtain a first solid-state composite electrolyte layer;
mixing a second mixture including a polymer matrix, an inorganic filler, a sodium salt, a plasticizer, and a conductive agent, into a second organic solvent by magnetic stirring to obtain a second solid-state composite electrolyte slurry; wherein, in the second mixture, the mass ratio of the polymer matrix ranges from 15 wt. %˜95 wt. %, the mass ratio of the inorganic filler ranges from 0.5 wt. %˜70 wt. %, and the molar ratio of the sodium ions in sodium salt to polymer monomers in polymer matrix is (0˜1):20; and the mass ratio of the plasticizer ranges from 0.5 wt. %˜20 wt. %, the mass ratio of the conductive agent ranges from 1 wt. %˜10 wt. %; and
knife coating the second solid-state composite electrolyte slurry onto the first solid-state composite electrolyte layer, air-blast drying and vacuum drying to obtain an asymmetric sodium-based solid-state composite electrolyte.

9. The method according to claim 8, wherein the first organic solvent or the second organic solvent is one or more of acetone, N,N-Dimethylformamide, and N-Methyl-2-pyrollidone.

10. The method according to claim 8, wherein the first organic solvent or the second organic solvent is a mixture of the acetone and N,N-dimethylformamide with the mass ratio ranging from (1˜25):1; or the first organic solvent or the second organic solvent is a mixture of the acetone and N-Methyl-2-pyrollidone with the mass ratio ranging from (1˜25):1.

11. The method according to claim 8, wherein the first solid-state composite electrolyte slurry is coated on a Teflon mold, followed by air-blast drying with the temperature ranging from 25° C.˜80° C. for 20 min˜120 min; the second solid-state composite electrolyte layer air-blast drying with temperature ranging from 25° C.˜80° C. for 30 min˜180 min, then vacuum drying with temperature ranging from 45° C.˜80° C. for 12 h˜36 h.

12. A sodium-ion battery, wherein the sodium-ion battery comprises a positive electrode, a negative electrode, and an asymmetric sodium-based solid-state composite electrolyte positioned between the positive electrode and the negative electrode, wherein the asymmetric sodium-based solid-state composite electrolyte comprises a first solid-state composite electrolyte layer contiguous with the positive electrode, and a second solid-state composite electrolyte layer disposed between the first solid-state composite electrolyte layer and the negative electrode, wherein:
the first solid-state composite electrolyte layer comprises a first polymer matrix and a first sodium salt; and
the second solid-state composite electrolyte layer comprises a second polymer matrix, a second sodium salt, and an electron conductive agent, wherein the mass ratio of the electron conductive agent ranges from 1 wt. %˜10 wt. %.

13. The sodium-ion battery according to claim 12, wherein the mass ratio of the first polymer matrix ranges from 15 wt. %˜95 wt. %, the first solid-state composite electrolyte layer further comprises a first inorganic filler with the mass ratio ranging from 0.5 wt. %˜70 wt. %, and the molar ratio of sodium ions in the first sodium salt to polymer monomers in the first polymer matrix is (0˜1):20.

14. The sodium-ion battery according to claim 12, wherein the second composite solid-state composite electrolyte layer comprises a second inorganic filler with the mass ratio ranging from 0.5 wt. %˜70 wt. %, the mass ratio of the second polymer matrix with the mass ranges from 15 wt. %˜95 wt. %, and the molar ratio of sodium ions in the second sodium salt to polymer monomers in the second polymer matrix is (0˜1):20.

15. The sodium-ion battery according to claim 14, wherein the first inorganic filler or the second inorganic filler is one or more of Si, Al₂O₃, AlCl₃, BaTiO₃, CuO, SiO₂, ZrO₂, TiO₂, Na₁₊ₓZr₂SiₓP₃₋ₓO₁₂, and NaMM′P₃O₁₂, wherein 0<x<3, the M and M′ are any one of the Si²⁺, Mg²⁺, Cu²⁺, Co²⁺, Zn²⁺, Mn²⁺, Fe²⁺, Al³⁺, Cr³⁺, Sc³⁺, Y³⁺, La³⁺, Ti⁴⁺, Zr⁺⁴, Ge⁴⁺, Sn⁴⁺, Nb⁴⁺, V⁵⁺, Nb⁵⁺, and Ta⁵⁺; M and M′ can be the same element or not. and the first sodium salt or the second sodium salt is one or more of NaClO₄, NaPF₆, NaAsF₆, NaBF₄, NaTFSI, NaTf, NaFSI and NaBOB.

16. The sodium-ion battery according to claim 12, wherein the first solid-state composite electrolyte layer further comprises a first plasticizer with the mass ratio ranging from 0.5 wt. %˜20 wt. %; and
the second solid-state composite electrolyte layer further comprises a second plasticizer with the mass ratio ranging from 0.5 wt. %˜20 wt. %;
the first plasticizer or the second plasticizer is one or more of succinonitrile, polystyrene, ethylene carbonate, propylene carbonate, polyethylene glycol, polyethylene glycol dimethyl ether, tetraethylene glycol, triethylene glycol dimethyl ether, diethyl phthalate, dioctyl phthalate, cyclic phosphate, dibutyl phthalate, and dimethyl phthalate.

17. The sodium-ion battery according to claim 12, wherein the mass ratio of the first solid-state composite electrolyte layer to the second solid-state composite electrolyte layer is (1˜8):1.

18. The sodium-ion battery according to claim 12, wherein the first polymer matrix or the second polymer matrix is one or more of polyethylene oxide, polyacrylonitrile, poly (methyl methacrylate), poly (vinyl alcohol), polyvinylpyrrolidone, polyvinylidene fluoride, poly (vinylidene fluoride-hexafluoropropylene), polypropylene carbonate, and polyethylene carbonate; or
the electron conductive agent is one or more of graphite, graphene, carbon nanotubes, acetylene black, and Ketjen Black carbon.
